(19) United States
(12) Patent Application Publication
(10) Pub. No.: US 2024/0148031 A1
(43) Pub. Date: May 9, 2024

(54) DRY PASTA AND METHOD FOR MANUFACTURING SAME

(71) Applicants: Nisshin Seifun Welna Inc., Tokyo (JP); NISSHIN FLOUR MILLING INC., Tokyo (JP); NISSHIN SEIFUN GROUP INC., Tokyo (JP)

(72) Inventors: Kenta ASAHINA, Fujimino-shi (JP); Tomoyuki FUJII, Fujimino-shi (JP); Kenji NAKAMURA, Fujimino-shi (JP); Atsuyuki MIYATA, Tokyo (JP)

(73) Assignees: Nisshin Seifun Welna Inc., Tokyo (JP); NISSHIN FLOUR MILLING INC., Tokyo (JP); NISSHIN SEIFUN GROUP INC., Tokyo (JP)

(21) Appl. No.: 18/280,838

(22) PCT Filed: Mar. 24, 2022
(86) PCT No.: PCT/JP2022/013853

§ 371 Date: Sep. 7, 2023

(30) Foreign Application Priority Data
Mar. 26, 2021 (JP) 2021-053760

(51) Int. Cl. A23L 7/109

(52) U.S. Cl. CPC A23L 7/109

(57) ABSTRACT

Dried pasta contains 5 parts by mass or more and 40 parts by mass or less of bran derived from white wheat, which is common wheat, in 100 parts by mass of a flour ingredient. It is preferable that the dried pasta further contains 50 parts by mass or more and 95 parts by mass or less of pulverized durum wheat in 100 parts by mass of the flour ingredient. It is also preferable that the white wheat is at least one of Australian Standard White and Western White. It is also preferable that the bran derived from the white wheat has been heat-treated. It is also preferable that the dried pasta has a noodle strand shape.

### TECHNICAL FIELD

The present invention relates to dried pasta and a method for producing the same.

### BACKGROUND ART

In recent years, due to increasing health consciousness, wheat bran, which is rich in nutrients, such as dietary fiber, vitamins, and minerals, as well as functional ingredients and has a good flavor, is used to produce secondary processed products such as noodles and bread.

Wheat bran includes the following types: red wheat-derived bran and white wheat-derived bran. Red wheat-derived bran is commonly used because it is widely commercially available. However, pasta supplemented with red wheat-derived bran and pasta made with whole wheat flour are brown and opaque and cannot be said to have a good appearance. Moreover, pasta supplemented with red wheat-derived bran and pasta made with whole wheat flour have a bitter or acrid taste, have a strong grain odor, and have a rough texture that is abrasive to the throat when being swallowed. In addition, dried pasta made with red wheat-derived bran or whole wheat flour through a high-temperature drying process tends to have cracks.

Then, the applicant of the present invention has previously proposed a method for producing pasta having an excellent appearance and texture despite containing wheat bran, by adjusting the moisture content of wheat kernels (see Patent Literature 1).

Also, Patent Literature 2 discloses a wheat flour composition for pasta in which durum wheat bran is mixed at a ratio of 1 to 30 parts by mass with respect to 70 to 99 parts by mass of durum wheat, for the purpose of producing pasta with an excellent flavor, texture, and appearance.

### CITATION LIST

### Patent Literature

Patent Literature 1: JP 2009-232742A

Patent Literature 2: JP 2019-129712A

### SUMMARY OF INVENTION

The technique disclosed in Patent Literature 1 has the advantage of being able to efficiently produce pasta having an excellent appearance and texture. However, when the pasta is chewed for a long time, the acrid taste of wheat bran may be perceived.

With the technique disclosed in Patent Literature 2, processing takes time and effort because, in general, durum wheat bran is not readily available, and pasta containing durum wheat bran is somewhat hard.

Therefore, it is an object of the present invention to provide dried pasta made with wheat bran that is less likely to cause an acrid taste and a grain odor and is readily available, as well as a method for producing the same.

The present invention provides dried pasta containing 5 parts by mass or more and 40 parts by mass or less of bran derived from white wheat, which is common wheat, in 100 parts by mass of a flour ingredient.

Also, the present invention provides a method for producing dried pasta, the method including a step of mixing 5 parts by mass or more and 40 parts by mass or less of bran derived from white wheat, which is common wheat, in 100 parts by mass of a flour ingredient.

### DESCRIPTION OF EMBODIMENTS

Hereinafter, the present invention will be described based on a preferred embodiment thereof. The present invention relates to dried pasta and a method for producing the same. As used herein, the term “dried pasta” refers to pasta that has been adjusted to have a moisture content of less than 15 mass %.

The dried pasta of the present invention contains a flour ingredient and bran derived from white wheat, which is common wheat.

The flour ingredient includes a cereal flour component and a starch component.

Examples of the cereal flour component include: heat-treated common wheat-derived bran; pulverized durum wheat; and wheat flour derived from common wheat; as well as rice flour, rye flour, corn flour, barley flour, sticky barley flour, soybean flour, oat flour, and other cereal flours (including heat-treated ones); non-heat-treated wheat-derived bran; heat-treated durum wheat-derived bran; and the like.

Examples of the starch component include: unmodified starches derived from cereal flours, such as waxy corn starch, corn starch, tapioca starch, potato starch, wheat starch, and rice starch; and modified starches obtained by subjecting any of the unmodified starches to at least one process selected from crosslinking, phosphorylation, acetylation, etherification, oxidation, and gelatinization. The flour ingredient is typically in powder form.

In particular, it is preferable that the dried pasta of the present invention contains 50 parts by mass or more and 95 parts by mass or less of pulverized durum wheat in 100 parts by mass of the flour ingredient, because this can improve the texture of the pasta. In view of this, the amount of pulverized durum wheat contained in the dried pasta of the present invention is more preferably 60 parts by mass or more and 95 parts by mass or less, and even more preferably 70 parts by mass or more and 95 parts by mass or less, in 100 parts by mass of the flour ingredient.

Wheat bran is used in the dried pasta of the present invention. As the wheat bran, a residual portion of a wheat grain obtained by removing the endosperm from the wheat grain, a portion of this residual portion obtained by further removing the germ from the residual portion, or the like, which are produced in a common wheat flour production process, may be used. The method for producing wheat bran typically includes the steps of adding water to and conditioning carefully-selected wheat kernels as necessary, then pulverizing the wheat kernels, and sorting the pulverized product using a sifter, a purifier, or the like, to remove the endosperms and the germs. There is no particular limitation on the method for pulverizing the wheat kernels. For example, a roll pulverization method or an impact pulverization method may be used, and a combination of a plurality of pulverization methods may also be used. There is no limitation on the pulverizer used for the impact pulverization method as long as pulverization is performed by mechanical impact between an impact plate and a rotating rotor. For example, a turbo mill, a blade mill, or the like may be used, and a turbo mill is particularly preferable.

In the present invention, bran derived from common wheat is used as the wheat bran. Common wheat refers to wheat that belongs to the common wheat species based on a botanical classification and is different from the aforementioned durum wheat. Specifically, ordinary wheats other than durum wheat are hexaploid and are called “common wheat species”. On the other hand, durum wheat is tetraploid and is called a “double-grain wheat species”. Thus, durum wheat is botanically different in type from the common wheat species used for strong flour, medium-strength flour, and soft flour. In the present invention, the use of bran derived from common wheat as the wheat bran has the advantage of making it possible to produce dried pasta with excellent secondary processability and an excellent texture. Another advantage is that bran derived from common wheat is easier to process, especially to pulverize, than durum wheat bran.

Common wheat can be broadly divided into two types, red wheat and white wheat, according to the color observed when the kernel is viewed. Red wheat is wheat that contains a red pigment in the outer hull, and is observed as red, reddish brown, or brown when the wheat kernel is viewed. On the other hand, white wheat is wheat that substantially does not contain a red pigment in the outer hull, and is observed as white or pale yellow when the wheat kernel is viewed. In the present invention, of these, bran derived from white wheat (hereinafter also referred to simply as “white wheat-derived bran”) is used as the bran derived from common wheat. The use of white wheat-derived bran makes it possible to obtain dried pasta that is unlikely to have an acrid taste and a grain odor. In addition, the use of white wheat-derived bran makes it possible to produce dried pasta that is unlikely to crack during production.

Specific examples of white wheat, which is common wheat, include Australian Standard White (ASW, produced in Australia; Note that ASW as used herein means Australian Standard White Noodle blend, ASWN blend (ASWNB)), Prime Hard (PH, produced in Australia), Soft White (SW, produced in the USA), Western White (WW, produced in the USA), and the like. In the present invention, one or more of these types of white wheat may be used. These types of white wheat can be appropriately sorted based on their genetic characteristics, for example.

Common wheat can also be broadly divided into three types, hard wheat, soft wheat, and intermediate wheat, which has a hardness intermediate between hard and soft, according to the hardness of the wheat kernel. Of these types, in order to further improve the flavor and texture of the resulting noodles, it is preferable to use white wheat that is classified as intermediate or soft wheat, and it is more preferable to use white wheat that is classified as intermediate wheat.

Considering the above-described white wheat and common wheat, for example, examples of hard wheat include PH and the like. Examples of intermediate wheat include ASW and the like. Specific examples of soft wheat include WW and the like.

For the reasons described above, it is preferable to use white wheat-derived wheat bran, of those types of common wheat bran that can be used in the dried pasta of the present invention, and it is more preferable to use at least one of ASW and WW, and even more preferable to use ASW. As a result of using white wheat-derived bran as an ingredient of the dried pasta, pasta having a favorable flavor as expected from a grain and being useful in terms of enhancing health can be obtained. In addition, the use of white wheat-derived bran makes it less likely that the resulting pasta will have an acrid taste caused by wheat bran, and facilitates an improvement in the taste.

In the present invention, it is preferable to use heat-treated bran as the bran derived from white wheat, which is common wheat. The use of heat-treated white wheat-derived bran makes it even less likely that the resulting pasta will have an acrid taste and a grain odor. In addition, cracking is even less likely to occur during production of the dried pasta.

Moreover, the white wheat-derived bran that has been heat-treated can be finely pulverized, which is advantageous in that white wheat-derived bran having a small particle size can be obtained with high productivity. Furthermore, the heat treatment can reduce or deactivate the activities of various enzymes such as amylase and protease, which is particularly advantageous in that the processability and texture of the pasta can be further improved.

Whether or not white wheat-derived bran has been heat-treated can be judged, for example, by measuring enzyme activity or gluten vitality. Specifically, taking enzyme activity as an example, the enzyme activity of heat-treated white wheat-derived bran is lower than that of unheated white wheat-derived bran, or below the detection limit, and therefore, heat-treated white wheat-derived bran and unheated white wheat-derived bran can be distinguished from each other in this respect.

The heat treatment applied to the white wheat-derived bran may be wet heat treatment or dry heat treatment.

Wet heat treatment is a process of heating the white wheat-derived bran, which is a target to be treated, while maintaining the moisture in the treatment target or supplying moisture from the outside to the treatment target. In wet heat treatment, moisture such as water, saturated steam, or superheated steam can be supplied and used. There is no particular limitation on the heating method used in wet heat treatment, and examples thereof include a method in which moisture is added to the treatment target in a closed environment before a heat medium such as hot air is brought into direct contact with the treatment target; a method in which high-temperature steam is brought into contact with the treatment target to heat the treatment target with the latent heat of condensation; and a method in which the treatment target is heated in a high humidity atmosphere.

Dry heat treatment is a process of heating the white wheat-derived bran, which is the treatment target, under conditions without adding moisture, and is performed while actively evaporating the moisture in the treatment target. Dry heat treatment can be performed, for example, by heating the target in an oven, heating the target in a roasting kiln, heating the target using a thermostatic chamber, heating the target by blowing hot air onto the target, or leaving the target in a high temperature and low humidity environment. Note that a process of applying warm air to the wheat bran and thereby drying the wheat bran after, for example, adding water thereto does not impart sufficient heat to the treatment target due to the latent heat of evaporation of moisture, and therefore, this process is not included in the dry heat treatment.

Specific examples of the heat treatment applied to white wheat-derived bran include: 1) wet heat treatment of white wheat-derived bran, which is the treatment target, to raise the temperature of the white wheat-derived bran to 80° C. or above (hereinafter also referred to as “wet heat treatment α”); and 2) dry heat treatment of white wheat-derived bran, which is the treatment target, to raise the temperature of the white wheat-derived bran to 80° C. or above (hereinafter also referred to as “dry heat treatment (β”).

With regard to the conditions for the wet heat treatment α, for example, the temperature of white wheat-derived bran, which is the treatment target, is preferably set to 80° C. or above and 110° C. or below, or more preferably 85° C. or above and 95° C. or below, and the treatment time (time during which the above-described temperature is maintained) is preferably set to 1 second or longer and 60 seconds or shorter, or more preferably 3 seconds or longer and 30 seconds or shorter.

The wet heat treatment α can be performed by, for example, introducing white wheat-derived bran, which is the treatment target, and saturated steam into a powder/granule heating apparatus disclosed in Japanese Patent No. 2784505, and using conditions of the above-described temperature and the above-described time. This powder/granule heating apparatus includes a cylindrical pressure vessel, with a saturated steam blowing inlet, for containing an object to be treated, and an agitating means having, mounted on a rotating shaft, a plurality of rod-shaped blades of a length close to the inner radius of the cylindrical vessel, the agitating means being configured to transfer a powder/granule charged into the vessel through an inlet port located at one end of the vessel toward a discharge port located at the other end of the vessel while agitating the powder/granule.

With regard to the conditions for the dry heat treatment β, for example, the temperature of white wheat-derived bran, which is the treatment target, is preferably set to 80° C. or above and 200° C. or below, more preferably 110° C. or above and 180° C. or below, or even more preferably 115° C. or above and 150° C. or below, and the treatment time (time during which the above-described temperature is maintained) is preferably set to 3 minutes or longer and 120 minutes or shorter, or more preferably 3 minutes or longer and 90 minutes or shorter. The dry heat treatment β can be performed by, for example, introducing white wheat-derived bran into an apparatus having a similar configuration to that of a heat-treatment and agitation apparatus disclosed in JP 2004-9022A and using conditions of the above-described temperature and the above-described time. This heat-treatment and agitation apparatus includes a cylindrical vessel for containing an object to be treated, a rotating shaft with a hollow structure, the rotating shaft being provided inside the vessel, a hollow pipe screw formed in communication with the shaft, and a steam supply source that supplies steam into the rotating shaft and the pipe screw, and the apparatus is configured to be able to perform dry heat treatment by transmitting heat transferred to the rotating shaft and the pipe screw from steam supplied into the rotating shaft and the pipe screw, to the object to be treated via the rotating shaft and the pipe screw.

In the present invention, wet heat treatment, in particular, is preferably performed as the heat treatment. Wet heat treatment has the advantage that the resulting pasta is even less likely to have an acrid taste and a grain odor. In addition, wet heat treatment is less likely to destroy fibers than dry heat treatment, and thus, after a subsequent drying step, fine surface irregularities are more likely to remain on the resulting dried pasta. As a result, the pasta obtained using the present production method allows a sauce to stick well to the pasta.

When the dried pasta is produced using heat-treated white wheat-derived bran, in order for the resulting pasta to have a smoother texture, the heat-treated white wheat-derived bran preferably has an average particle size of less than 200 more preferably 20 μm or more and less than 200 μm even more preferably 20 μm or more and 150 μm or less, and yet even more preferably 40 μm or more and 120 μm or less. As used herein, the average particle size refers to the cumulative volume particle size D₅₀ at a cumulative volume of 50 vol % when measured by a dry method using a laser diffraction and scattering particle size distribution measurement apparatus (for example, a “Microtrac particle size analyzer 9200FRA” available from Nikkiso Co., Ltd.).

Heat-treated white wheat-derived bran having the above-described average particle size can be easily obtained by, for example, performing classification using a sieve, an air classifier, or the like. When classifying white wheat-derived bran using a sieve, preferably, a sieve having an opening size of 150 μm or more and 200 μm or less, or more preferably 150 μm or more and 180 μm or less, is used, and a fraction passing through the sieve is collected.

When classifying white wheat-derived bran using an air classifier, a classifier capable of accurately separating a fraction within a particle size range of 150 μm or more and 200 μm or less is used, and a fraction preferably having an average particle size of 200 μm or less, or more preferably having an average particle size of 150 μm or less, is collected.

For space saving purposes, it is preferable to perform pulverization and classification using an impact fine-pulverizer with a built-in air classifier. An example of the impact fine-pulverizer with a built-in air classifier is ACM Pulverizer (trade name) manufactured by Hosokawa Micron Corporation.

In the present invention, it is preferable that dried pasta is obtained by mixing 5 parts by mass or more and 40 parts by mass or less of white wheat-derived bran in 100 parts by mass of the flour ingredient. Setting the amount of white wheat-derived bran to 5 parts by mass or more ensures that the amount of white wheat-derived bran mixed is sufficient to proclaim the nutritional function thereof. Setting the amount of white wheat-derived bran to 40 parts by mass or less makes it unlikely that the pasta will have an acrid taste and a grain odor. In addition, cracking is unlikely to occur during production of the dried pasta. In view of these, the amount of white wheat-derived bran is more preferably 10 parts by mass or more and 30 parts by mass or less, or even more preferably 10 parts by mass or more and 25 parts by mass or less, in 100 parts by mass of the flour ingredient.

The dried pasta of the present invention is suitably produced using a production method including: a step of obtaining pasta by shaping a dough obtained by mixing 5 parts by mass or more and 40 parts by mass or less of bran derived from white wheat, which is common wheat, in 100 parts by mass of a flour ingredient; and a drying step of drying the pasta.

There is no particular limitation on the method for mixing the flour ingredient and the white wheat-derived bran as long as they can be uniformly mixed, and a known mixing apparatus commonly used in the art may be used.

The dough used in the present production method is typically prepared by adding kneading water to a raw material powder containing the flour ingredient and the white wheat-derived bran, mixing, and kneading the mixture. To prepare the dough, in addition to the raw material powder and the kneading water, other components, such as a saccharide, a thickening agent, protein, an emulsifier, an oil/fat, brine, and a seasoning, may also be used. As the kneading water, any type of water that usually can be used to produce a dough may be used without particular limitation. For example, clear water, acidic water, alkaline water, brine, and the like may be used as the kneading water. The amount of kneading water to be added may be an amount that is usually used in the production of pasta, and is typically 20 parts by mass or more and 40 parts by mass or less with respect to 100 parts by mass of the raw material powder.

The pasta can be obtained by extruding the dough prepared from the raw material powder, under a predetermined pressure. The dough can be extruded in accordance with an ordinary method using a shaping machine (pasta making machine) usually used in the production of pasta.

A shaping machine typically includes a cylinder, a screw that is disposed such that the screw is movable in the cylinder along the axial direction of the cylinder, and a die (extrusion die) located at one end of the cylinder in the axial direction. In the shaping machine having the above-described configuration, when the dough is supplied into the cylinder, with the screw rotating on the axis of the cylinder, the dough is advanced in the cylinder toward the die as the screw rotates, while being compressed under a high pressure between an inner wall of the cylinder and the screw, and is then continuously extruded through holes in the die.

Preferably, a vacuum extrusion method is used to extrude the dough. In the vacuum extrusion method, typically, the dough is fed to a vacuum mixer, degassed and compressed while being kneaded under reduced pressure at a gauge pressure of about −600±100 mmHg, and then directed to the die under a high pressure of around 80 kg/cm². The dough that has been fed to the die is extruded through holes provided in the die and thus formed into a desired pasta shape.

When white wheat-derived bran is used as the bran contained in the dough, fibers are unlikely to be destroyed during vacuum extrusion of the dough, and thus, fine surface irregularities are likely to remain on the resulting dried pasta after the subsequent drying step. As a result, the pasta obtained using the present production method allows a sauce to stick well to the pasta.

There is no particular limitation on the shape of the pasta, and, for example, the pasta may be noodle strand-shaped pasta such as spaghetti or fettuccine, tubular pasta such as macaroni or penne, or sheet-shaped pasta such as lasagna. As described above, the dried pasta of the present invention has the advantage of allowing a sauce to stick well thereto, and it is preferable that the dried pasta has a noodle strand shape, which is a shape that makes this advantage even more marked.

In the present production method, the pasta formed by extruding the dough is dried. The pasta that has been dried, or in other words, the dried pasta to be produced according to the present invention preferably has a moisture content of 13 mass % or less from the viewpoint of enabling long-term storage of the dried pasta at room temperature. The moisture content here refers to a value as measured using an absolute dry method. As the method for drying the pasta, a drying method usually used in the production of dried pasta of this type may be used as appropriate. For example, the ambient temperature is preferably 55° C. or above and 95° C. or below, more preferably 60° C. or above and 95° C. or below, and even more preferably 70° C. or above and 95° C. or below. In the case where the pasta formed by extruding the dough has a noodle strand shape, even when the pasta is dried within this temperature range, in particular, on a high temperature side within this temperature range, the resulting dried pasta is unlikely to have cracks. The reason for this is that the dough contains white wheat-derived bran.

With the above-described production method, dried pasta that is unlikely to have cracks and also is likely to have fine surface irregularities remaining thereon even after a high-temperature drying step can be obtained while reducing the acrid taste and the grain odor caused by wheat bran. Pasta having fine surface irregularities has an advantageous effect of allowing a sauce to stick better to the pasta when the pasta is combined with the sauce.

### Examples

Hereinafter, the present invention will be described in further detail using examples. However, the scope of the present invention is not limited to the examples given below.

### Example 1

(1) Production of wet heat-treated white wheat bran

White heat, ASW was used as raw material wheat. Carefully selected caryopses of the wheat were pulverized using a roll pulverizer, and the pulverized product was then classified with a sieve having an opening size of 200 μm to collect a wheat bran fraction as the residue on the sieve.

The collected wheat bran fraction was subjected to impact fine-pulverization using a turbo mill (manufactured by Tokyo Seifunki Mfg., Co., Ltd.), and the resulting pulverized product was then subjected to wet heat treatment under conditions at a temperature of the pulverized product of 90° C. for 5 seconds while saturated steam was introduced using a powder/granule heating apparatus disclosed in Japanese Patent No. 2784505.

The wet heat-treated pulverized product was finely pulverized using an impact fine-pulverizer (ACM Pulverizer, manufactured by Hosokawa Micron Corporation) and then classified with a sieve having an opening size of 150 μm, and a classified fraction passing through the sieve and having a particle size of less than 150 μm was separated to obtain an intended product, wet heat-treated white wheat bran. The obtained wheat bran had an average particle size of about 90 μm.

(2) Production of dried pasta

Ingredients shown in Table 1 were mixed to obtain a raw material powder. The raw material powder was used to prepare a dough. The dough was formed into a noodle strand shape to obtain fresh noodle strands. The fresh noodle strands were dried to produce dried pasta, the dried pasta being dried noodles. In Table 1, Leone G is durum flour, semolina.

More specifically, the dough was subjected to vacuum extrusion to obtain fresh noodle strands with a diameter of 1.6 mm. A pasta machine MAC60 (manufactured by ITALPAST) was used for the vacuum extrusion. The fresh noodle strands were heated to 80° C. for 45 minutes and dried at 80° C. to 90° C. for 240 minutes in an environment with 65 to 75% RH humidity. Thus, intended dried spaghetti was produced.

### Examples 2 and 3

A dough was prepared at the mixing ratio shown in Table 1. Otherwise, similar procedures to those of Example 1 were performed, and thus, dried spaghetti was produced.

### Comparative Examples 1 and 2

(1) Production of red wheat bran

Red wheat, Western Red Spring 1 (1CW, produced in Canada) was used as raw material wheat. In a manner similar to that of Example 1, a red wheat bran fraction was collected from the above red wheat and subjected to impact fine-pulverization using a turbo mill to obtain a pulverized product.

The pulverized product was subjected to dry heat treatment by heating the pulverized product for 25 minutes so that the temperature of the pulverized product reached 120° C. using an apparatus having a similar configuration to that of the heat-treatment and agitation apparatus disclosed in JP 2004-9022A.

The dry heat-treated pulverized product was finely pulverized using the impact fine-pulverizer used in Example 1 and then classified with a sieve having an opening size of 150 μm, and a classified fraction passing through the sieve and having a particle size of less than 150 μm was separated to obtain an intended product, dry heat-treated red wheat bran. The obtained wheat bran had an average particle size of about 90 μm.

(2) Production of dried pasta

Dried spaghetti was produced using similar procedures and conditions to those of Example 1.

### Control

A dough was prepared at the mixing ratio shown in Table 1. Otherwise, similar procedures to those of Example 1 were performed, and thus, dried spaghetti was produced. This dried spaghetti did not contain wheat bran.

### Evaluation

The dried spaghetti obtained in the examples and the comparative examples and as the control were evaluated for low bran odor and how well a sauce stuck thereto, using the following methods. The results are shown in Table 1.

The dried spaghetti obtained in the examples and the comparative examples and as the control were boiled for 8 minutes. The flavor of the spaghetti was evaluated by 10 expert panelists based on the following evaluation criteria (1). The higher the arithmetic mean of the scores, the less bran odor was perceived.

In addition, spaghetti combined with meat sauce was eaten by the expert panelists, and how well the meat sauce stuck to the spaghetti was evaluated based on the following evaluation criteria (2). The higher the arithmetic mean of the scores, the better the sauce stuck to the spaghetti.

### Evaluation Criteria (1)

5 points: Almost no bran odor was perceived.

4 points: Bran odor was weak.

3 points: Slight bran odor was perceived, but caused no problem.

2 points: Bran odor was perceived.

1 point: Strong bran odor was perceived.

### Evaluation Criteria (2)

5 points: Sauce stuck much better to the test spaghetti than to the control.

4 points: Sauce stuck better to the test spaghetti than to the control.

3 points: Sauce stuck somewhat better to the test spaghetti than to the control.

2 points: Sauce stuck to the test spaghetti as well as to the control.

1 point: Sauce stuck less to the test spaghetti than to the control.

TABLE 1

| | | | | | Com. | Com. | |
|---|---|---|---|---|---|---|---|
| | | Ex. 1 | Ex. 2 | Ex. 3 | Ex. 1 | Ex. 2 | Control |
| Dough | Wet heat-treated white wheat | 10 | 20 | 30 | | | |
| | bran [parts by mass] | | | | | | |
| | Dry heat-treated red wheat | | | | 10 | 20 | |
| | bran [parts by mass] | | | | | | |
| | Leone G [parts by mass] | 90 | 80 | 70 | 90 | 80 | 100 |
| | Water added [%] | 31 | 33 | 35 | 31 | 33 | 29 |
| Evaluation | Low bran odor [point] | 4.5 | 4.0 | 3.5 | 3.5 | 3.0 | 5.0 |
| | How well sauce stuck to | 3.5 | 4.0 | 4.5 | 3.0 | 3.7 | 2.0 |
| | spaghetti [point] | | | | | | |
| | Total evaluation score [point] | 8.0 | 8.0 | 8.0 | 6.5 | 6.7 | 7.0 |

It is clearly seen from the results shown in Table 1 that the dried spaghetti obtained in the examples had less bran odor than the dried spaghetti of the comparative examples and also allowed the sauce to stick better thereto.

### Example 4 and Comparative Example 3

A dough was prepared at the mixing ratio shown in Table 1. The dough was formed into a noodle strand shape to obtain fresh noodle strands. The fresh noodle strands were heated to 80° C. for 45 minutes and dried at 80° C. to 90° C. for 240 minutes in a slightly lower humidity environment with 50 to 70% RH humidity. The above-described drying conditions tend to cause cracks in dried spaghetti. Otherwise, similar procedures to those of Example 1 were performed, and thus, dried spaghetti was produced.

### Evaluation

Fifty strands each of the dried spaghetti obtained in Example 4 and Comparative Example 3 were individually visually examined to measure the frequency of occurrence of cracks. The results are shown in Table 2.

TABLE 2

| | | | Com. |
|---|---|---|---|
| | | Ex. 4 | Ex. 3 |
| Dough | Wet heat-treated white wheat [parts by mass] | 20 | |
| | Dry heat-treated red wheat [parts by mass] | | 20 |
| | Leone G [parts by mass] | 80 | 80 |
| | Water added [%] | 29 | 31 |
| Evaluation | Number of cracks [number] | 17/50 | 30/50 |
| | Non-defective percentage [%] | 66 | 40 |

It is clearly seen from the results shown in Table 2 that the dried spaghetti obtained in Example 4 had fewer cracks than the dried spaghetti of Comparative Example 3.

### Industrial Applicability

According to the present invention, dried pasta made with wheat bran that is less likely to cause an acrid taste and a grain odor and is readily available, as well as a method for producing the same are provided.

1. Dried pasta comprising 5 parts by mass or more and 40 parts by mass or less of bran derived from white wheat, which is common wheat, in 100 parts by mass of a flour ingredient.

2. The dried pasta according to claim 1, further comprising 50 parts by mass or more and 95 parts by mass or less of pulverized durum wheat in 100 parts by mass of the flour ingredient.

3. The dried pasta according to claim 1, wherein the white wheat is at least one of Australian Standard White and Western White.

4. The dried pasta according to claim 1, wherein the bran derived from the white wheat has been heat-treated.

5. The dried pasta according to claim 1, which has a noodle strand shape.

6. A method for producing dried pasta, comprising a step of mixing 5 parts by mass or more and 40 parts by mass or less of bran derived from white wheat, which is common wheat, in 100 parts by mass of a flour ingredient.

7. The production method according to claim 6, the method comprising a step of drying, at 55° C. or above and 95° C. or below, noodle strands obtained from a dough containing the flour ingredient and the bran.
